(19) United States
(12) Patent Application Publication
(10) Pub. No.: US 2026/0258765 A1
(43) Pub. Date: Sep. 3, 2026

(54) CONTROL DEVICE FOR EXHAUST GAS CONTROL APPARATUS

(71) Applicant: TOYOTA JIDOSHA KABUSHIKI KAISHA, Toyota-shi (JP)

(72) Inventors: Kentaro MINEO, Gotemba-shi (JP); Masato IKEMOTO, Sunto-gun (JP)

(73) Assignee: TOYOTA JIDOSHA KABUSHIKI KAISHA, Toyota-shi (JP)

(21) Appl. No.: 19/422,903

(22) Filed: Dec. 17, 2025

(30) Foreign Application Priority Data
Mar. 3, 2025 (JP) 2025-033224

(51) Int. Cl. F02D 41/14; F02D 41/02

(52) U.S. Cl. CPC F02D 41/1446; F02D 41/0235; F02D 41/0295; F02D 2200/0802

(57) ABSTRACT

A control device is for an exhaust gas control apparatus provided in an exhaust system of an internal combustion engine and including a catalyst configured to remove at least NOx from exhaust gas. The control device performs control for catalyst de-poisoning when the catalyst is poisoned. The control device includes a controller that performs catalyst de-poisoning control based on the detection result of NOx downstream of the catalyst. The controller determines that the degree of catalyst poisoning is large when a detected value of NOx is greater than or equal to a first reference value, determines that the degree of catalyst poisoning is small when the detected value of NOx is smaller than a second reference value, sets the air-fuel ratio to lean when the degree of catalyst poisoning is large, and stops fuel supply to the rotating internal combustion engine when the degree of catalyst poisoning is small.

### CROSS-REFERENCE TO RELATED APPLICATION

This application claims priority to Japanese Patent Application No. 2025-033224 filed on March 3, 2025. The disclosure of the above-identified application, including the specification, drawings, and claims, is incorporated by reference herein in its entirety.

### BACKGROUND

### 1. Technical Field

The technology of the present disclosure relates to a device for controlling an exhaust gas control apparatus that removes or reduces air pollutants in exhaust gas emitted from an engine etc. mounted on a vehicle, and more particularly to a device for recovering a catalyst from poisoning.

### 2. Description of Related Art

As an example of an exhaust gas control apparatus mounted on a vehicle, an NOx storage-reduction three-way catalyst is known in which catalyst particles such as Pt, Rh, or CeO₂ are supported on a heat-resistant substrate. In this type of catalyst apparatus, substances such as CO and hydrocarbons (HC) are oxidized and rendered harmless, and NOx is rendered harmless by being absorbed as nitrate under a lean atmosphere and released as nitrogen under a rich atmosphere. Such reactions occur when pollutants in the exhaust gas come into contact with the catalyst. However, the catalyst may become poisoned by substances such as sulfur and HC contained in the exhaust gas, and as the degree of poisoning of the catalyst increases, its exhaust gas control performance deteriorates, resulting in NOx being emitted into the atmosphere.

Various devices and methods for detecting catalyst poisoning have been proposed. As one example, Japanese Unexamined Patent Application Publication No. 2016-023617 (JP 2016-023617 A) describes a device for detecting sulfur poisoning of a catalyst in an apparatus that controls exhaust gas from an engine mounted on a vehicle. The device determines whether to recover the three-way catalyst from sulfur poisoning based on the NOx concentration detected by an NOx sensor after an air-fuel ratio control unit changes the air-fuel ratio of the exhaust gas from a rich air-fuel ratio to a lean air-fuel ratio and before the air-fuel ratio detected by an air-fuel-ratio sensor shifts to a lean air-fuel ratio. Alternatively, the device includes a determination unit that determines that the degree of sulfur poisoning of the three-way catalyst is higher when the NOx concentration detected by the NOx sensor is high than when the NOx concentration detected by the NOx sensor is low.

Japanese Unexamined Patent Application Publication No. 2012-117458 (JP 2012-117458 A) describes an exhaust gas control apparatus that removes sulfur poisoning by oxidizing sulfur poisoning the catalyst. In the device disclosed in JP 2012-117458 A, sulfur that poisons the noble metal of the catalyst is oxidized at a lean air-fuel ratio at a catalyst bed temperature higher than or equal to a predetermined temperature. The sulfur is thus converted into SOx and released, thereby achieving de-poisoning. In view of this, when the catalyst bed temperature is lower than the minimum temperature of the temperature range in which the sulfur poisoning the noble metal of the catalyst can be oxidized and released at a lean air-fuel ratio, the device raises the catalyst bed temperature to or above the minimum temperature by heat generated from a chemical heat storage material, and thereafter performs lean air-fuel ratio control by fuel cut.

Japanese Unexamined Patent Application Publication No. 2012-241652 (JP 2012-241652 A) describes a catalyst degradation detection device designed to suppress a decrease in accuracy of detecting catalyst degradation caused by poisoning of a catalyst having an oxygen storage capacity. The device calculates, for each of a lean air-fuel ratio and a rich air-fuel ratio, an oxygen excess or deficiency amount flowing into the catalyst during a time until an output value of an exhaust gas sensor changes. The device then calculates the oxygen storage amount of the catalyst based on the calculated oxygen excess or deficiency amount, and detects catalyst degradation based on the calculated oxygen storage amount. The device also estimates the degree of poisoning that reduces the oxygen release rate of the catalyst, and delays switching of the air-fuel ratio from rich to lean according to the estimated degree of poisoning. The device described in JP 2012-241652 A has the above configuration. Therefore, when catalyst poisoning that decreases the oxygen release rate of the catalyst occurs, the effect of this catalyst poisoning can be reflected in the air-fuel ratio control used for calculating the oxygen storage amount, thereby reducing the likelihood of the accuracy of catalyst degradation detection being reduced due to catalyst poisoning.

Japanese Unexamined Patent Application Publication No. 2010-071141 (JP 2010-071141 A) describes a device configured to perform fuel cut operation to suppress HC poisoning of the catalyst, thereby minimizing deterioration in the exhaust gas control performance of the catalyst and maintaining good exhaust quality.

Japanese Unexamined Patent Application Publication No. 2004-052597 (JP 2004-052597 A) describes an exhaust gas control apparatus for an internal combustion engine that can recover a catalyst from sulfur poisoning. This apparatus determines the degree of degradation of the exhaust gas control catalyst, and changes either or both of a control variable and a control duration of catalyst de-poisoning control according to the degree of degradation. The catalyst de-poisoning control is implemented as control for making the air-fuel ratio rich or retarding the ignition timing.

### SUMMARY

The device described in JP 2016-023617 A is configured to detect sulfur poisoning of a catalyst, and JP 2016-023617 A does not describe any technique for de-poisoning the catalyst or recovering the catalyst from the sulfur poisoning.

In contrast, the apparatus described in JP 2012-117458 A is configured to de-poison the catalyst by controlling the air-fuel ratio to lean. However, since lean control increases the amount of NOx emitted as a result of fuel combustion in the internal combustion engine, the amount of NOx emissions may increase during the catalyst de-poisoning process, and as a result, the total amount of NOx emissions from the vehicle may increase.

The device described in JP 2012-241652 A detects catalyst degradation caused by poisoning, but no consideration is given to recovery from catalyst poisoning. In particular, in a three-way catalyst, the amount of NOx emissions increases as catalyst poisoning progresses, and the amount of NOx emissions may also increase during a de-poisoning operation. However, JP 2012-241652 A does not disclose anything regarding these points.

JP 2010-071141 A describes a control device configured to relieve HC poisoning of a catalyst by lean operation. However, JP 2010-071141 A discloses neither technology related to poisoning of a storage-reduction three-way catalyst caused by substances such as sulfur, nor technology for de-poisoning the catalyst. In particular, JP 2010-071141 A does not disclose anything regarding NOx emissions caused by poisoning due to substances such as sulfur, or NOx emissions associated with de-poisoning.

JP 2004-052597 A describes controlling the air-fuel ratio to lean to relieve sulfur poisoning of a catalyst. However, in a three-way catalyst for exhaust gas control, NOx is emitted when a lean atmosphere is established to relieve poisoning of the catalyst caused by substances such as sulfur. JP 2004-052597 A does not disclose any control related to the amount of NOx emissions, and there remains room for improvement in exhaust gas control including NOx.

The present disclosure has been made in view of the circumstances described above, and an object thereof is to provide a control device for an exhaust gas control apparatus that enables both recovery of a catalyst from poisoning and reduction in the amount of NOx emissions associated with recovery of the catalyst from poisoning.

In order to achieve the above object, the technology of the present disclosure is a control device for an exhaust gas control apparatus provided in an exhaust system of an internal combustion engine configured to change an air-fuel ratio. The exhaust gas control apparatus includes a catalyst configured to remove at least NOx from exhaust gas. The control device is configured to perform control for catalyst de-poisoning when the catalyst is poisoned. The control device includes a controller configured to perform catalyst de-poisoning control on the catalyst based on the result of detection of NOx downstream of the catalyst. The controller is configured to: determine that the degree of poisoning of the catalyst is a large degree when a detected value of the NOx is greater than or equal to a first reference value determined in advance; determine that the degree of poisoning of the catalyst is a small degree when the detected value of the NOx is smaller than a second reference value determined in advance; set the air-fuel ratio to lean when the degree of poisoning of the catalyst is determined to be the large degree; and stop supply of fuel to the internal combustion engine that is rotating, when the degree of poisoning of the catalyst is determined to be the small degree.

In the technology of the present disclosure, the controller may be configured to perform control for stopping the supply of fuel when the degree of poisoning of the catalyst decreases from the large degree to the small degree.

In the technology of the present disclosure, the second reference value may be either equal to or smaller than the first reference value.

In the technology of the present disclosure, the exhaust gas control apparatus may include a first catalyst disposed upstream in a flow direction of the exhaust gas, a second catalyst disposed downstream of the first catalyst, and an NOx sensor disposed downstream of the second catalyst, and the controller may be configured to determine whether the catalyst is poisoned based on a detected value obtained by the NOx sensor.

In the technology of the present disclosure, the controller may further be configured to determine that the degree of poisoning of the catalyst is a slight degree when the detected value of the NOx is less than or equal to a third reference value determined in advance, the third reference value being smaller than the second reference value, and not to perform the catalyst de-poisoning control when the degree of poisoning of the catalyst is determined to be the slight degree.

In the technology of the present disclosure, when the degree of poisoning of the catalyst is the large degree, lean control of the air-fuel ratio is performed. The lean control includes both control for making the air-fuel ratio lean and control for making the air-fuel ratio even leaner when the air-fuel ratio is already lean. During the lean control, NOx is emitted from the internal combustion engine. However, the catalyst poisoning is gradually relieved, and therefore NOx is reduced by the catalyst. As a result, the amount of NOx in the exhaust gas that has passed through the catalyst decreases. When the degree of poisoning of the catalyst is the small degree, fuel cut control is performed. Accordingly, NOx is not emitted from the internal combustion engine, and de-poisoning of the catalyst further proceeds. As a result, the catalyst can be recovered from poisoning while suppressing NOx emissions.

In particular, when the degree of poisoning of the catalyst is the large degree, the air-fuel ratio is controlled to be lean to recover the catalyst from poisoning. When the degree of poisoning of the catalyst is subsequently reduced to the small degree, fuel cut control is performed. With this configuration, generation of NOx does not continue at the lean air-fuel ratio after the catalyst has been recovered from poisoning. Accordingly, it is possible to suppress NOx emissions associated with de-poisoning of the catalyst.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an exhaust system of an internal combustion engine for a vehicle according to the technology of the present disclosure;

FIG. 2 is a block diagram showing a functional configuration of a controller;

FIG. 3 is a flowchart illustrating an example of control performed by the controller;

FIG. 4A is a graph showing how the degree of catalyst poisoning changes when catalyst de-poisoning control for setting the air-fuel ratio to lean and subsequent fuel cut control are performed and when catalyst de-poisoning control is not performed, in a case where the degree of catalyst poisoning is large;

FIG. 4B is a graph showing how an accumulated amount of NOx emissions changes when catalyst de-poisoning control for setting the air-fuel ratio to lean and subsequent fuel cut control are performed and when catalyst de-poisoning control is not performed, in a case where the degree of catalyst poisoning is large;

FIG. 5A is a graph showing how the degree of catalyst poisoning changes when catalyst de-poisoning control for setting the air-fuel ratio to lean and subsequent fuel cut control are performed and when catalyst de-poisoning control is not performed, in a case where the degree of catalyst poisoning is small;

FIG. 5B is a graph showing how an accumulated amount of NOx emissions changes when catalyst de-poisoning control for setting the air-fuel ratio to lean and subsequent fuel cut control are performed and when catalyst de-poisoning control is not performed, in a case where the degree of catalyst poisoning is small;

FIG. 6A is a time chart schematically showing an example of changes in the air-fuel ratio (A/F), a flag indicating execution of control for setting the air-fuel ratio to lean (lean execution flag), a flag indicating a request for fuel cut control (F/C request flag), and an instantaneous value of an NOx sensor according to the technology of the present disclosure in a case where the degree of catalyst poisoning is large;

FIG. 6B is a time chart schematically showing an example of changes in the air-fuel ratio (A/F), a flag indicating a request for fuel cut control (F/C request flag), and an instantaneous value of an NOx sensor according to the technology of the present disclosure in a case where the degree of catalyst poisoning is small.

### DETAILED DESCRIPTION OF EMBODIMENTS

Next, an embodiment of the present disclosure will be described with reference to the accompanying drawings. The embodiment described below is merely an example of implementing the technology of the present disclosure and is not intended to limit the technology of the present disclosure.

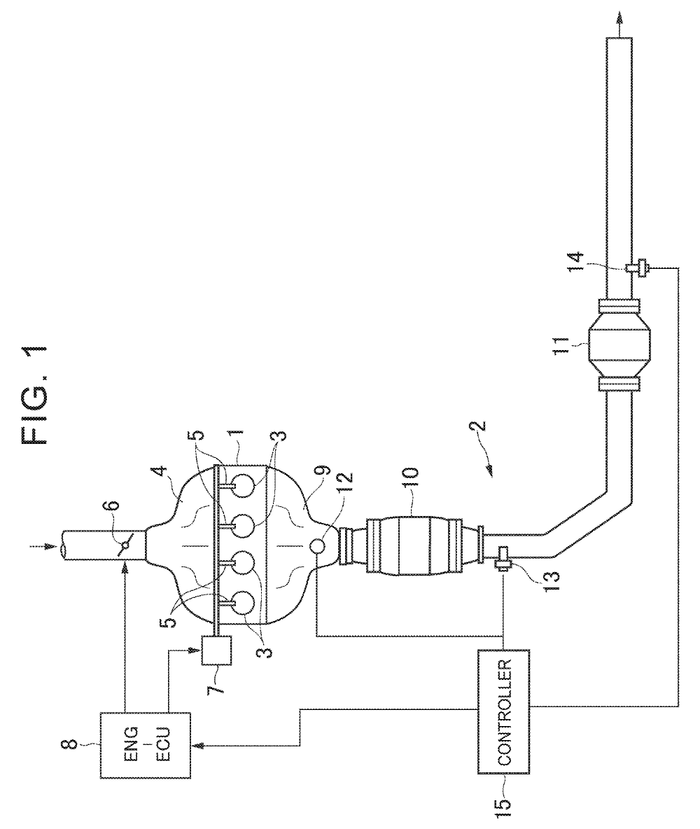

First, the configuration of an exhaust gas control apparatus of the embodiment will be described. FIG. 1 schematically shows an exhaust system 2 of an internal combustion engine (hereinafter simply referred to as "engine") 1 for a vehicle. The engine 1 has a plurality of cylinders 3. Each cylinder 3 draws in air via an intake manifold 4, and fuel is directly injected into each cylinder 3 by an injector 5 provided for the respective cylinder 3. The engine 1 outputs power by explosively burning a mixture of the intake air and the injected fuel inside each cylinder 3.

The ratio of air to fuel constituting the air-fuel mixture is the air-fuel ratio (A/F). The intake air amount is adjusted by a throttle valve 6 provided upstream of the intake manifold 4, and the amount of fuel injected by each injector 5 is adjusted by an injection unit 7 controlling, for example, the duty cycle or injection pulse width of each injector 5. The theoretical (stoichiometric) air-fuel ratio for complete fuel combustion is 14.6 (14.6 parts of air to 1 part of fuel). An air-fuel ratio greater than this is a lean air-fuel ratio, and an air-fuel ratio smaller than this is a rich air-fuel ratio. The air-fuel ratio is controlled based on various factors such as a requested drive amount indicated by, for example, the amount of depression of an accelerator pedal (not shown), the coolant temperature of the engine 1, the vehicle speed, the air-fuel ratio detected in the exhaust system, and a detection signal from a knock sensor. Depending on the traveling state of the vehicle, fuel injection into the rotating engine 1 may be stopped. This is referred to as "fuel cut control (F/C)." The opening degree of the throttle valve 6, that is, the intake air amount, and the amount of fuel injected by each injector 5 are controlled by an engine computer (engine electronic control unit (ENG-ECU)) 8. The ENG-ECU 8 may have a conventionally known configuration.

An exhaust manifold 9 is connected to the exhaust ports (not shown) of the engine 1, and a first catalyst device 10 (also referred to as "warm-up catalyst" or "pre-catalyst") and a second catalyst device 11 (also referred to as "underfloor catalyst" or "main catalyst") are connected in this order downstream of the exhaust manifold 9 in the exhaust flow direction. These catalyst devices 10, 11 are similar to conventionally known devices, and include catalysts that oxidize substances such as CO and HC to render them harmless and storage-reduction catalysts that render NOx harmless.

A front A/F sensor 12 that detects the air-fuel ratio of exhaust gas flowing into the first catalyst device 10 is provided upstream of the first catalyst device 10. A rear A/F sensor 13 that detects the air-fuel ratio of the exhaust gas discharged from the first catalyst device 10 (that is, the exhaust gas flowing into the second catalyst device 11) is provided downstream of the first catalyst device 10. An NOx sensor 14 that detects the concentration of NOx in the exhaust gas discharged from the second catalyst device 11, that is, the concentration of NOx emitted to the atmosphere from the exhaust system 2, is provided downstream of the second catalyst device 11. The series of devices from the exhaust manifold 9 to the NOx sensor 14 constitutes the exhaust gas control apparatus of the present embodiment.

The sensors 12, 13, and 14 are connected to a controller 15, and are configured to input detection signals, that is, detected data, into the controller 15. The controller 15 detects or determines poisoning of the catalysts (not shown) in the catalyst devices 10, 11 caused by substances such as sulfur and hydrocarbons (HC) (hereinafter simply referred to as "poisoning"), and performs air-fuel ratio control including fuel cut based on the determination. The controller 15 is a main electronic control unit (main ECU) for catalyst de-poisoning control, and is an electronic control unit mainly configured with a microcomputer including a processing element (central processing unit (CPU)), storage elements (a random access memory (RAM) and a read-only memory (ROM)), and various interfaces. The controller 15 is configured to perform computations according to a stored program using input data and prestored data, and output the computation results as control command signals.

The input data include the NOx concentration detected by the NOx sensor 14 and the data detected by the A/F sensors 12, 13. The prestored data include first to third reference values used to determine the degree of catalyst poisoning. The control command signals include a signal for performing or inhibiting catalyst de-poisoning control, a signal for instructing or requesting control for setting the air-fuel ratio to lean, and a signal for instructing or requesting fuel cut control, namely control in which fuel supply is stopped while a vehicle (not shown) equipped with the engine 1 is traveling and the engine 1 is rotating. The control for setting the air-fuel ratio to lean includes control for making a rich or stoichiometric air-fuel ratio lean and control for making an already lean air-fuel ratio even leaner.

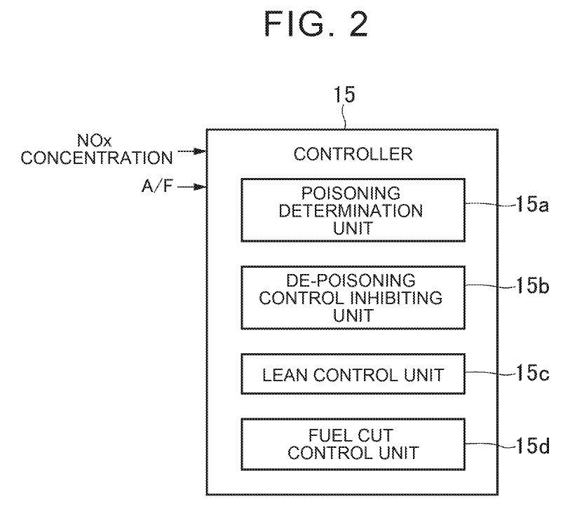

The controller 15 has the functional configuration shown in FIG. 2 in order to perform the above control. The controller 15 determines whether to perform catalyst de-poisoning control, based on the received NOx concentration (detected value). That is, the controller 15 includes a poisoning determination unit 15a that determines, based on the detected NOx value, whether the catalyst is poisoned and the degree of catalyst poisoning. In the exhaust gas control apparatus shown in FIG. 1, the NOx concentration of exhaust gas that has passed through the second catalyst device 11 is detected. Therefore, it is not possible to determine whether poisoning has occurred in the first catalyst device 10 or in the second catalyst device 11. Accordingly, the first catalyst device 10 and the second catalyst device 11 are regarded as a single catalyst device, and poisoning of that catalyst device is determined.

When the NOx concentration is low and it is therefore determined that the catalyst is not poisoned, a command signal is output to inhibit catalyst de-poisoning control, or no command signal for performing catalyst de-poisoning control is output. Specifically, when the detected NOx value is less than or equal to the third reference value, a signal is output to inhibit catalyst de-poisoning control. The controller 15 includes a de-poisoning control inhibiting unit 15b that performs such control.

The poisoning determination unit 15a determines the degree of catalyst poisoning based on the detected NOx concentration. When the detected NOx value is greater than or equal to the first reference value, it is determined that the degree of catalyst poisoning is large. When the degree of catalyst poisoning is smaller than the second reference value, it is determined that the degree of catalyst poisoning is small. The second reference value may be the same as the first reference value. However, in order to suppress control hunting, it is preferable to provide hysteresis between the two reference values by setting the second reference value to a value smaller than the first reference value.

The controller 15 further includes a lean control unit 15c. The lean control unit 15c sets the air-fuel ratio to lean or requests setting of the air-fuel ratio to lean, when it is determined that the degree of catalyst poisoning is large. When the air-fuel ratio is set to lean, NOx is likely to be produced due to combustion of the air-fuel mixture in the engine 1. However, since the atmosphere in a poisoned catalyst becomes a lean atmosphere (oxidizing atmosphere), combustion of poisoning substances such as sulfur and hydrocarbons proceeds, and the catalyst is gradually recovered from poisoning. As a result, NOx is rendered harmless by the catalyst that has been recovered from poisoning. Therefore, when lean control is performed, both generation of NOx and conversion of NOx into harmless components occur. Therefore, the lean air-fuel ratio is determined in advance through experiments or simulations such that the total amount of NOx is reduced.

The controller 15 further includes a fuel cut control unit 15d. The fuel cut control unit 15d performs or requests fuel cut control, when it is determined that the degree of catalyst poisoning is small because the detected NOx value is smaller than the second reference value. As described above, fuel cut control is performed when various conditions are satisfied while the vehicle is traveling and the engine 1 is rotating. Therefore, even when it is determined that the degree of catalyst poisoning is small, fuel cut control is not performed immediately and may be performed when other conditions are satisfied.

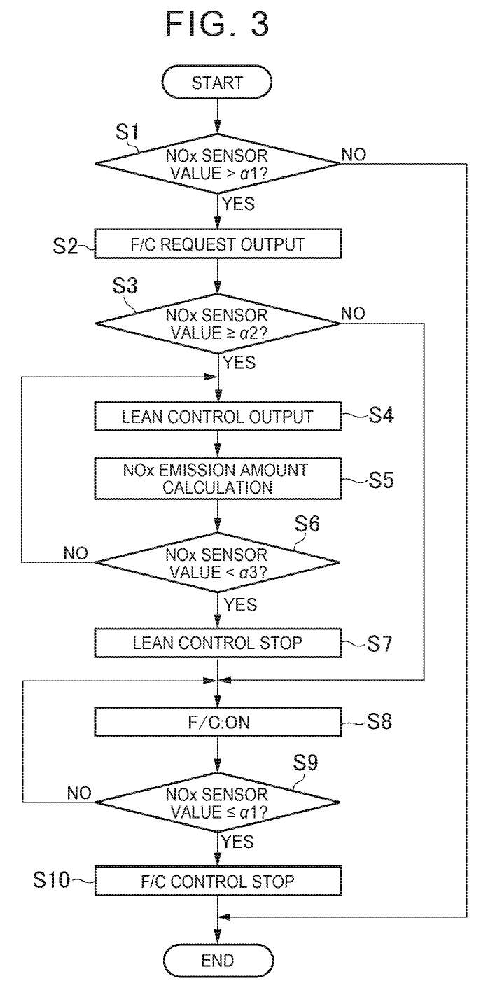

An example of control performed by the controller 15 having the above configuration will be described with reference to FIG. 3. The routine shown in FIG. 3 is repeatedly executed at predetermined short time intervals while the vehicle (not shown) equipped with the engine 1 is traveling or while the engine 1 is operating. In the control example shown in FIG. 3, it is first determined in step S1 whether the NOx sensor value is greater than a predetermined value α1. The predetermined value α1 is a reference value used to determine whether the catalyst is poisoned, and is obtained through, for example, experiments or simulations. The predetermined value α1 corresponds to the third reference value in the present embodiment.

When the determination result in step S1 is "NO," the degree of catalyst poisoning is slight and does not need catalyst de-poisoning control. Therefore, the routine shown in FIG. 3 ends without performing any particular control. That is, catalyst de-poisoning control is not performed. Accordingly, the control in step S1 corresponds to the control performed by the poisoning determination unit 15a described above. The control that proceeds to END in FIG. 3 without performing any particular control corresponds to the control performed by the de-poisoning control inhibiting unit 15b described above.

When the determination result in step S1 is "YES," a request for fuel cut (F/C) control, which is an example of catalyst de-poisoning control, is output in step S2. This control corresponds to satisfying, in advance, one of the conditions for performing fuel cut control. In this control, a request for fuel cut control is output such that fuel cut control is immediately performed when another condition is satisfied such as when the vehicle enters a coasting state, or when fuel cut control for catalyst de-poisoning becomes permissible.

Next, in step S3, it is determined whether the degree of catalyst poisoning is large, that is, whether the detected NOx value is greater than or equal to another predetermined value α2 (> α1). The determination in step S3 corresponds to the control performed by the poisoning determination unit 15a described above. The predetermined value α2 corresponds to the first reference value in the present embodiment. As catalyst poisoning progresses, NOx in the exhaust gas is no longer reduced by the catalyst, and therefore the NOx concentration at the position where the NOx sensor 14 is installed increases.

When the determination result in step S3 is "YES," the degree of catalyst poisoning is large. Therefore, a command signal is output in step S4 to perform control for setting the air-fuel ratio to lean as catalyst de-poisoning control. The lean air-fuel ratio used in this case may be determined in advance through, for example, experiments or simulations as described above. The control in step S4 corresponds to the control performed by the lean control unit 15c described above.

In step S5, the amount of NOx emitted under the condition in which the control for setting the air-fuel ratio to lean is performed in step S4 is calculated. The calculated amount of NOx is accumulated.

In step S6, it is determined whether the detected NOx sensor value is smaller than a further predetermined value α3. The predetermined value α3 may be the same value as the predetermined value α2 used to determine whether the degree of catalyst poisoning is large, or may be a value smaller than the predetermined value α2 and greater than the predetermined value α1 used to determine whether the catalyst is poisoned. When the determination result in step S6 is "YES," the control for setting the air-fuel ratio to lean is terminated and fuel cut control may be performed. Therefore, from the viewpoint of suppressing control hunting, it is preferable that the predetermined value α3 be smaller than the predetermined value α2. It is preferable that, at the time the control for setting the air-fuel ratio to lean is terminated, the catalyst has been recovered to such an extent that NOx can be rendered harmless. Accordingly, the predetermined value α3 is determined in advance through, for example, experiments or simulations so as to achieve such a state. The predetermined value α3 corresponds to the second reference value in the present embodiment.

When the determination result in step S6 is "NO," the routine returns to step S4 and the control for setting the air-fuel ratio to lean is continued. On the other hand, when the determination result in step S6 is "YES," the control for setting the air-fuel ratio to lean is stopped in step S7.

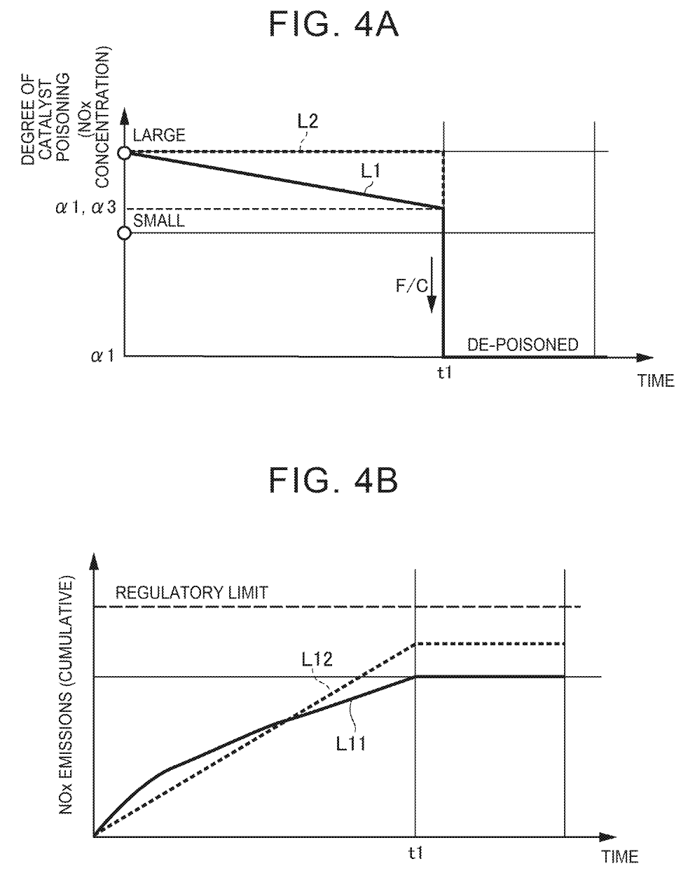

FIGS. 4A and 4B respectively show how the degree of catalyst poisoning and the accumulated amount of NOx emissions change when the air-fuel ratio is set to lean due to a large degree of catalyst poisoning. FIG. 4A schematically illustrates changes in the degree of catalyst poisoning. Line L1 shows how the degree of catalyst poisoning changes when the air-fuel ratio is set to lean as described above, and line L2 shows the degree of catalyst poisoning when no control for catalyst de-poisoning is performed.

When the air-fuel ratio is set to lean, an oxidizing atmosphere with excess oxygen is produced in the first catalyst device 10 and the second catalyst device 11. As a result, poisoning substances such as sulfur are burned and removed from the catalyst, and the catalyst is gradually recovered from poisoning as shown by line L1 in FIG. 4A. In contrast, when no control for catalyst de-poisoning is performed, the degree of catalyst poisoning naturally remains large as shown by line L2 in FIG. 4A.

The accumulated amount of NOx emissions during catalyst de-poisoning control, namely control for setting the air-fuel ratio to lean, changes as shown by line L11 in FIG. 4B. On the other hand, when no control for catalyst de-poisoning is performed, the accumulated amount of NOx emissions changes as shown by line L12 in FIG. 4B. That is, when the air-fuel ratio is set to lean, the amount of NOx generated by the engine 1 increases. Since the catalyst is poisoned, the amount of NOx emitted initially after the start of control becomes greater than in a case where no control for catalyst de-poisoning is performed and the catalyst remains poisoned. However, as the catalyst is gradually recovered from poisoning as described above, the amount of NOx reduced by the catalyst gradually increases. As a result, the amount of NOx emitted when catalyst de-poisoning control, that is, control for setting the air-fuel ratio to lean, is performed becomes smaller than the amount of NOx emitted when no control for catalyst de-poisoning is performed and the catalyst remains poisoned. when the amount of NOx emissions has decreased and the NOx sensor value falls below the predetermined value α2, that is, at time t1 in FIGS. 4A and 4B, the control for setting the air-fuel ratio to lean is stopped. Thus, both recovery of the catalyst from poisoning and a reduction in the amount of NOx emissions are achieved.

As shown in FIG. 3, when the control for setting the air-fuel ratio to lean as catalyst de-poisoning control is stopped in step S7, fuel cut control, which is requested as catalyst de-poisoning control in step S2, is performed when predetermined conditions are satisfied. That is, fuel cut control is turned on in step S8 in FIG. 3. The control in step S8 corresponds to the control performed by the fuel cut control unit 15d described above.

When fuel injection into the engine 1 is stopped while the engine 1 is rotating, such as when the vehicle enters a coasting state, air is supplied to the first and second catalyst devices 10, 11 by the pumping action of the engine 1, and the atmosphere in the catalyst becomes an oxidizing atmosphere. In addition, since combustion does not occur in the engine 1, neither NOx nor exhaust gas is generated. Accordingly, the oxidizing atmosphere in each of the catalyst devices 10, 11 causes poisoning substances such as sulfur and hydrocarbons adhering to the catalysts to be oxidized and released from the catalyst. Catalyst de-poisoning progresses in this manner.

In step S9 following step S8, it is determined whether the NOx sensor value is less than or equal to the predetermined value α1 while fuel cut control is being performed. This determination is the same as that in step S1 described above, and it is determined whether catalyst poisoning has been relieved.

When the determination result in step S9 is "NO," the routine returns to step S8 and fuel cut control is continued. On the other hand, when the determination result in step S9 is "YES," the request for fuel cut control is cancelled in step S10, and then the routine shown in FIG. 3 ends.

When the determination result in step S3 is "NO," the routine proceeds to step S8, and catalyst de-poisoning control by fuel cut control is performed. That is, when the determination result in step S3 is "NO," the catalyst is poisoned, but the degree of catalyst poisoning is small rather than large. The determination in step S3 corresponds to the control performed by the poisoning determination unit 15a described above. In this case, catalyst de-poisoning is performed by fuel cut control without performing control for setting the air-fuel ratio to lean.

The graph after time t1 in FIG. 4A shows how the degree of catalyst poisoning changes in a case where control for setting the air-fuel ratio to lean is switched to fuel cut control. The graph after time t1 in FIG. 4B shows how the accumulated amount of NOx emissions changes in that case. As shown in these graphs, when fuel cut control is performed at time t1, the degree of catalyst poisoning immediately decreases and catalyst poisoning is relieved. In other words, the catalyst is recovered from poisoning. This is also true when no control for catalyst de-poisoning is performed, as shown by line L2 in FIG. 4A. Fuel cut control functions to recover the catalyst from poisoning. Accordingly, as shown in FIG. 4B, after time t1, each of the catalyst devices 10, 11 operates normally and the amount of NOx emissions does not increase. When fuel cut control is not performed, the amount of NOx emissions continues to increase and eventually exceeds a regulatory limit shown in FIG. 4B, regardless of whether the air-fuel ratio is set to lean (as shown by line L11 in FIG. 4B) or no control for catalyst de-poisoning is performed (as shown by line L12 in FIG. 4B).

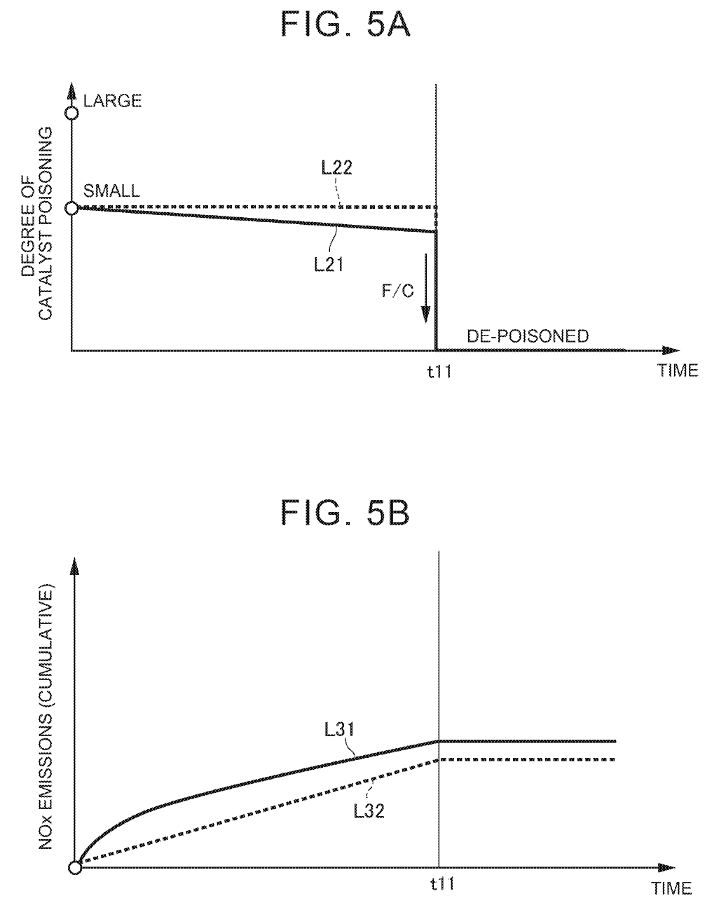

The reason why control for setting the air-fuel ratio to lean is switched to fuel cut control when the degree of catalyst poisoning is large, and the reason why fuel cut control is performed when the degree of catalyst poisoning is small, will be described. When the catalyst is poisoned to a small degree, it still has the ability to reduce NOx. When the air-fuel ratio is set to lean in this state, the amount of NOx generated by the engine 1 exceeds the amount of NOx that can be reduced by the catalyst, and therefore the accumulated amount of NOx emissions increases. This situation is shown in FIGS. 5A and 5B. FIG. 5A shows how the degree of catalyst poisoning changes when control for setting the air-fuel ratio to lean is performed as catalyst de-poisoning control and fuel cut control is subsequently performed in a case where the degree of catalyst poisoning is small. Line L21 shows how the degree of catalyst poisoning changes when the air-fuel ratio is set to lean, and line L22 shows how the degree of catalyst poisoning changes when no particular control is performed until fuel cut control is performed. FIG. 5B shows how the accumulated amount of NOx emissions changes when control for setting the air-fuel ratio to lean is performed as catalyst de-poisoning control and fuel cut control is subsequently performed in a case where the degree of catalyst poisoning is small. Line L31 shows how the accumulated amount of NOx emissions changes when the air-fuel ratio is set to lean, and line L32 shows how the accumulated amount of NOx emissions changes when no particular control is performed until fuel cut control is performed.

As shown in FIG. 5A, when control for setting the air-fuel ratio to lean is performed, the degree of catalyst poisoning decreases, although at a small rage, and catalyst poisoning is immediately relieved by performing fuel cut control at time t11. On the other hand, as shown in FIG. 5B, when the air-fuel ratio is set to lean (as shown by line L31), the amount of NOx generated by the engine 1 becomes large and exceeds the amount of NOx that can be reduced by the catalyst poisoned to a small degree. As a result, the accumulated amount of NOx emissions becomes greater than in a case where control for setting the air-fuel ratio to lean, that is, catalyst de-poisoning control, is not performed (as shown by line L32). This is also true even when fuel cut control is performed at time t11. That is, when the degree of catalyst poisoning is small and the air-fuel ratio is set to lean, the accumulated amount of NOx emissions becomes greater than in a case where the air-fuel ratio is not set to lean, and therefore there is no point in performing catalyst de-poisoning control. For this reason, when the degree of catalyst poisoning decreases to a small degree or when it is determined that the degree of catalyst poisoning is small, control for setting the air-fuel ratio to lean is not performed as catalyst de-poisoning control.

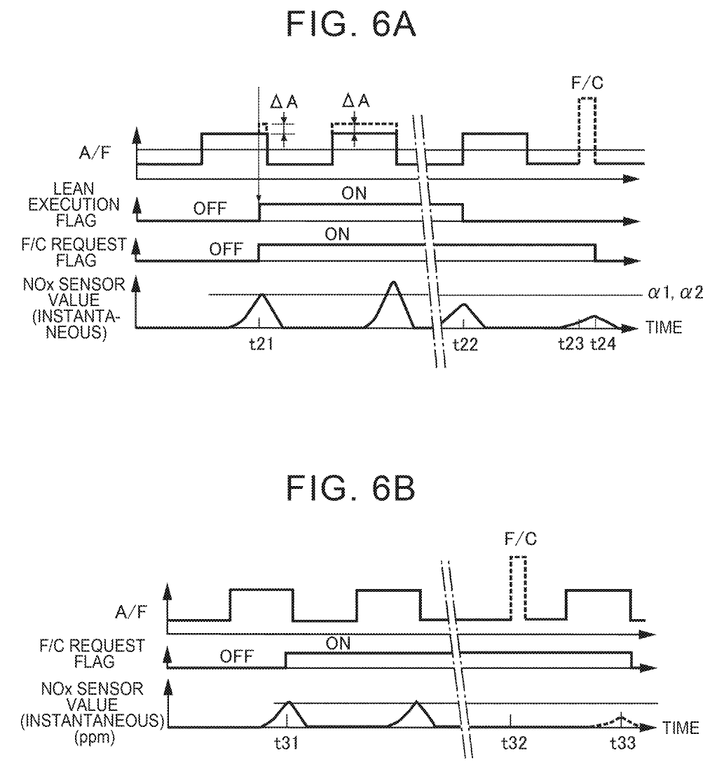

FIGS. 6A and 6B schematically show an example of changes in the air-fuel ratio (A/F), a flag indicating execution of control for setting the air-fuel ratio to lean (lean execution flag), a flag indicating a request for fuel cut control (F/C request flag), and an instantaneous value of the NOx sensor when the control shown in FIG. 3 is performed. FIG. 6A shows an example for a case where the degree of catalyst poisoning is large. While the engine 1 is operating at a predetermined air-fuel ratio, the NOx sensor value increases at time t21, and it is determined that the degree of catalyst poisoning is large. As a result, the lean execution flag and the F/C request flag are turned on.

When the lean execution flag is turned on, the air-fuel ratio increases by a predetermined amount ΔA from the previous air-fuel ratio and is controlled to be lean. After the engine 1 is operated at the lean air-fuel ratio for a predetermined period of time, the NOx sensor value becomes smaller than the predetermined value α2 at time t22, and control for setting the air-fuel ratio to lean is stopped accordingly.

Even after the air-fuel ratio is returned to the original air-fuel ratio, the F/C request flag remains on. Therefore, fuel cut control is performed at time t23 when other predetermined conditions are satisfied. As a result, catalyst poisoning is relieved, and the NOx sensor value further decreases. When the NOx sensor value becomes less than or equal to the predetermined value α1 at time t24, the lean execution flag is turned off accordingly.

FIG. 6B shows an example for a case where the degree of catalyst poisoning is small. Since control for setting the air-fuel ratio to lean is not performed when the degree of catalyst poisoning is small, no line corresponding to the lean execution flag is shown in FIG. 6B. While the engine 1 is operating at a predetermined air-fuel ratio, the NOx sensor value increases at time t31, and it is determined that the degree of catalyst poisoning is small. As a result, the F/C request flag is turned on.

Fuel cut control is performed when other conditions are satisfied such as when the accelerator pedal (not shown) is released and the vehicle enters a coasting state. Accordingly, fuel cut control may not be performed immediately even when the F/C request flag is turned on. In the example shown in FIG. 6B, operation is continued while maintaining the previous air-fuel ratio.

Then, fuel cut control is performed at time t32 when the conditions for performing fuel cut control are satisfied. As a result, oxidation of poisoning substances such as sulfur adhering to the catalyst proceeds, and catalyst poisoning is gradually relieved. When the NOx sensor value becomes less than or equal to the predetermined value α1 at time t33, the lean execution flag is turned off.

The present disclosure is not limited to the embodiment described above. The internal combustion engine may have any configuration as long as it can control the air-fuel ratio. The internal combustion engine may be an internal combustion engine other than a so-called direct injection internal combustion engine that injects fuel directly into the cylinder. The present disclosure is also applicable to an exhaust gas control apparatus other than one provided with two catalyst devices in the exhaust system.

What is claimed is:

1. A control device for an exhaust gas control apparatus provided in an exhaust system of an internal combustion engine configured to change an air-fuel ratio, the exhaust gas control apparatus including a catalyst configured to remove at least NOx from exhaust gas, the control device being configured to perform control for catalyst de-poisoning when the catalyst is poisoned, the control device comprising a controller configured to perform catalyst de-poisoning control on the catalyst based on a result of detection of NOx downstream of the catalyst,
wherein the controller is configured to
determine that a degree of poisoning of the catalyst is a large degree when a detected value of the NOx is greater than or equal to a first reference value determined in advance,
determine that the degree of poisoning of the catalyst is a small degree when the detected value of the NOx is smaller than a second reference value determined in advance,
set the air-fuel ratio to lean when the degree of poisoning of the catalyst is determined to be the large degree, and
stop supply of fuel to the internal combustion engine that is rotating, when the degree of poisoning of the catalyst is determined to be the small degree.

2. The control device according to claim 1, wherein the controller is configured to perform control for stopping the supply of fuel when the degree of poisoning of the catalyst decreases from the large degree to the small degree.

3. The control device according to claim 1, wherein the second reference value is either equal to or smaller than the first reference value.

4. The control device according to claim 1, wherein:
the exhaust gas control apparatus includes
a first catalyst disposed upstream in a flow direction of the exhaust gas,
a second catalyst disposed downstream of the first catalyst, and
an NOx sensor disposed downstream of the second catalyst; and
the controller is configured to determine whether the catalyst is poisoned based on a detected value obtained by the NOx sensor.

5. The control device according to claim 1, wherein the controller is further configured to
determine that the degree of poisoning of the catalyst is a slight degree when the detected value of the NOx is less than or equal to a third reference value determined in advance, the third reference value being smaller than the second reference value, and
not perform the catalyst de-poisoning control when the degree of poisoning of the catalyst is determined to be the slight degree.
